(19) United States
(12) Patent Application Publication
(10) Pub. No.: US 2010/0100542 A1
(43) Pub. Date: Apr. 22, 2010

(54) System and method for rule-based content customization for user presentation

(76) Inventors: Louis Hawthorne, Mill Valley, CA (US); Michael Renn Neal, Arvada, CO (US); d'Armond Lee Speers, Thornton, CO (US)

Correspondence Address: Goodwin Procter LLP;Attn: Patent Administrator, 135 Commonwealth Drive, Menlo Park, CA, 94025-1105, US

(21) Appl. No.: 12/407,932

(22) Filed: Mar. 20, 2009

Related U.S. Application Data
(63) Continuation-in-part of application No. 12/253,893, filed on Oct. 17, 2008.

(51) Int. Cl. G06F 17/30

(52) U.S. Cl. 707/732; 707/E17.108

(57) ABSTRACT

A new approach is proposed that contemplates systems and methods to present a script of content comprising one or more content items to a user online, wherein such content is not only relevant to addressing a problem raised by the user, but is also customized and tailored based on a set of rules with the user's needs and preferences in mind. Such an approach enables a personal “agent” that understands the user's specific needs and interests by maintaining a personal profile and history of the user. Based on in-depth personal knowledge and understanding, the agent is capable of identifying, retrieving, customizing, and presenting to the user a unique experience that distinguishes it from the experiences of any other users in the general public.

### CROSS-REFERENCE TO RELATED APPLICATIONS

This application is a continuation-in-part of U.S. patent application Ser. No. 12/253,893 filed Oct. 17, 2009 and entitled “A system and method for content customization based on user profile,” by Neal et al., and is hereby incorporated herein by reference.

### BACKGROUND

With the growing volume of content available over the Internet, people are increasingly seeking answers to their questions or problems online. Due to the overwhelming amount of information that is available online, however, it is often difficult for a lay person to browse over the Web and find the content that actually addresses his/her problem. Even when the user is able to find the content that is relevant to address his/her problem, such content is most likely to be of “one size fits all” type that addresses concerns of the general public but does not target the specific needs of the user as an individual or the presentation of the content is not adjusted for the needs and preferences of the user. Although some online vendors do keep track of web surfing and/or purchasing history or tendency of a user online for the purpose of recommending services and products to the user based on such information, such online footprint of the user is only passively gathered or monitored, which often does not truly reflect the user's real intention or interest. For a non-limiting example, the fact that a person purchased certain goods as gifts for his/her friend(s) is not indicative of his/her own interest in such goods.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

FIG. 1 depicts an example of a system diagram to support rule-based content customization for user presentation.

FIG. 2 illustrates an example of the various information that may be included in a user profile.

FIG. 3 depicts a flowchart of an example of a process to establish the user's profile.

FIG. 4 illustrates an example of various types of content items in a script of content and the potential elements in each of them.

FIG. 5 depicts a flowchart of an example of a process to support rule-based content customization for user presentation.

### DETAILED DESCRIPTION OF EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to present a script of content (also known as a user experience, referred to hereinafter as “content”) comprising one or more content items to a user online, wherein such content is not only relevant to addressing a problem raised by the user, but is also customized and tailored based on a set of rules with the user's needs and preferences in mind. Such an approach enables a personal “agent” that understands the user's specific needs and interests by maintaining a personal profile of the user. Such profile is more than a simple tracking of the user's activities online by further including feedback and answers provided by the user him/herself to prior engagements and/or “interview” questions by the agent. Based on such in-depth personal knowledge and understanding, the agent is capable of identifying, retrieving, customizing, and presenting the content to the user that specifically addresses his/her problem or concern. With such an approach, a user can efficiently and accurately find what he/she is looking for and have a unique experience that distinguishes it from the experiences by any other person in the general public.

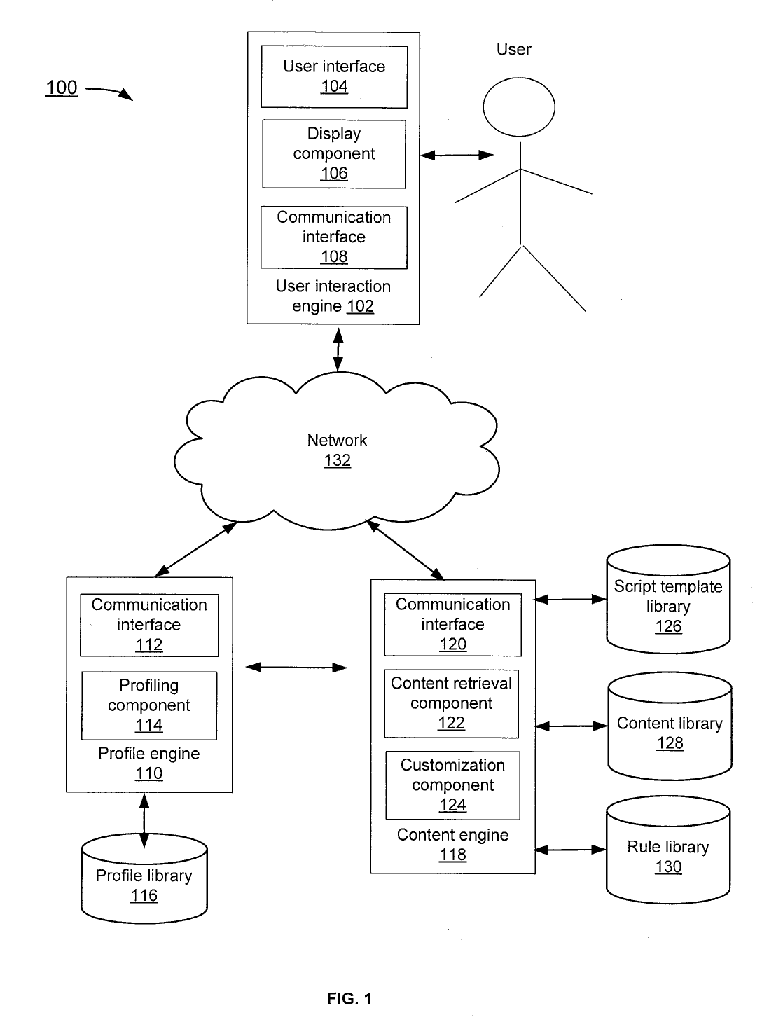

FIG. 1 depicts an example of a system diagram to support rule-based content customization for user presentation. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes a user interaction engine 102, which includes at least a user interface 104, a display component 106, and a communication interface 108; a profile engine 110, which includes at least a communication interface 112 and a profiling component 114; a profile library (database) 116 coupled to the profile engine 110; a content engine 118, which includes at least a communication interface 120, a content retrieval component 122, and a customization component 124; a script template library (database) 126, a content library (database) 128, a rule library (database) 130, all coupled to the content engine 118; and a network 132.

As used herein, the term engine refers to software, firmware, hardware, or other component that is used to effectuate a purpose. The engine will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

As used herein, the term library or database is used broadly to include any known or convenient means for storing data, whether centralized or distributed, relational or otherwise.

In the example of FIG. 1, each of the engines and libraries can run on one or more hosting devices (hosts). Here, a host can be a computing device, a communication device, a storage device, or any electronic device capable of running a software component. For non-limiting examples, a computing device can be but is not limited to a laptop PC, a desktop PC, a tablet PC, an iPod, a PDA, or a server machine. A storage device can be but is not limited to a hard disk drive, a flash memory drive, or any portable storage device. A communication device can be but is not limited to a mobile phone.

In the example of FIG. 1, the communication interface 108, 112, and 120 are software components that enables the user interaction engine 102, the profile engine 110, and the content engine 118 to communicate with each other following certain communication protocols, such as TCP/IP protocol. The communication protocols between two devices are well known to those of skill in the art.

In the example of FIG. 1, the network 132 enables the user interaction engine 102, the profile engine 110, and the content engine 118 to communicate and interact with each other. Here, the network 132 can be a communication network based on certain communication protocols, such as TCP/IP protocol. Such network can be but is not limited to, internet, intranet, wide area network (WAN), local area network (LAN), wireless network, BLUETOOTH, WiFi, and mobile communication network. The physical connections of the network and the communication protocols are well known to those of skill in the art.

In the example of FIG. 1, the user interaction engine 102 is configured to enable a user to submit a problem to which the user intends to seek help or counseling via the user interface 104 and to present to the user a script of a content relevant to addressing the problem submitted by the user via the display component 106. Here, the problem (or question, interest, issue, event, condition, or concern, hereinafter referred to a problem) of the user provides the context for the content that is to the presented to him/her. The problem can be related to one or more of personal, emotional, spiritual, relational, physical, practical, or any other need of the user. In some embodiments, the user interface 104 can be a Web-based browser, which allows the user to access the system 100 remotely via the network 132.

In some embodiments, the user interaction engine 102 presents a pre-determined list of problems that could possibly be raised by the user in the form of a list, such as a pull down menu, and the user may submit his/her problem by simply picking and choosing a problem in the menu. Such menu can be organized by various categories or topics in more than one level. By organizing and standardizing the potential problems from the user, the menu not only saves the user's time and effort in submitting the problems, but also makes it easier to identify relevant script templates and/or content items for the problem submitted.

In some embodiments, the user interaction engine 102 is configured to enable the user to provide feedback to the content presented to him/her via the user interface 104. Here, such feedback can be, for non-limiting examples, ratings or ranking of the content, indication of preference as whether the user would like to see the same or similar content in the same category in the future, or any written comments or suggestions on the content that eventually drives the customization of the content. For non-limiting examples, a rating can be from 0-10 where 0 is worst and 10 is best, or 5 stars. There can also be a comment by a user can be that he/she does not want to see content item such as poetry.

In some embodiments, the user interaction engine 102 is configured to enable the user to download or purchase the content presented to him/her via the user interface 104 via, for non-limiting examples, clicking of a button or choosing an option from a menu. Here, the content can be downloaded or purchased in the form of computer readable media, such as a collection of text, image, or multi-media documents or files, which can be saved to a storage medium and be accessed, played back, or displayed in the future. Alternatively, the content can be downloaded or purchased as a whole in the form of a printable media, such as a printable poster of images and quotes. As discussed in later text, the content and/or its presentation can be first customized before such content is downloaded or purchased.

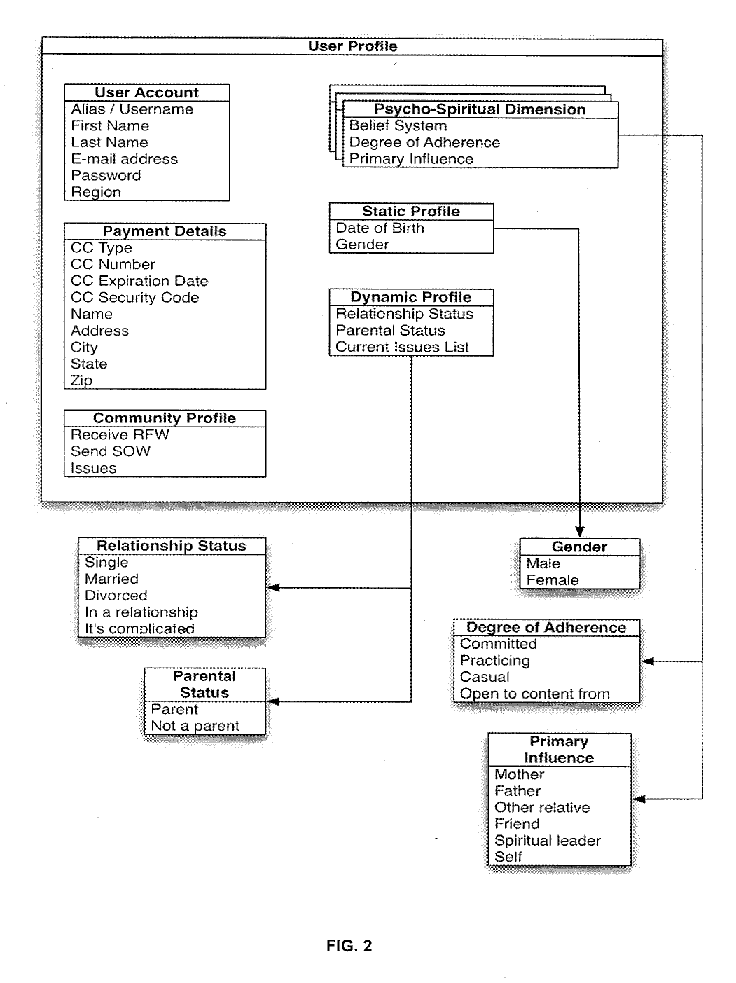

In the example of FIG. 1, the profile engine 110 manages a profile of the user maintained in the profile library 1 16 via the profiling component 1 14 for the purpose of generating and customizing the content to be presented to the user. The user profile may contain at least the following areas of user information:
Administrative information includes account information such as name, region, email address, and payment options of the user.
Static profile contains information of the user that does not change over time, such as the user's gender and date of birth to calculate his/her age and for potential astrological consideration.
Dynamic profile contains information of the user that may change over time, such as parental status, marital status, relationship status, as well as current interests, hobbies, habits, and concerns of the user. In addition, the dynamic profile may also contain ADA-Compliant information of the user, such as poor eyesight, hearing loss, etc., which reflects the user's present physical condition.
Psycho-Spiritual Dimension describes the psychological, spiritual, and religious component of the user, such as the user's belief system (a religious, philosophical or intellectual tradition, e.g., Christian, Buddhist, Jewish, atheist, non-religious), degree of adherence (e.g., committed/devout, practicing, casual, no longer practicing, “openness” to alternatives) and influences (e.g., none, many, parents, mother, father, other relative, friend, spouse, spiritual leader/religious leader, self).
Community Profile contains information defining how the user interacts with the online community of experts and professionals (e.g., which of the experts he/she likes or dislikes in the community and which problems to which the user is willing to receive request for wisdom (RFW) and to provide his/her own input on the matter).
   FIG. 2 illustrates an example of the various information that may be included in a user profile.

In some embodiments, the profile engine 110 initiates one or more questions to the user via the user interaction engine 102 for the purpose of soliciting and gathering at least part of the information listed above to establish the profile of the user. Here, such questions focus on the aspects of the user's life that are not available through other means. The questions initiated by the profile engine 110 may focus on the personal interests of the spiritual dimensions as well as dynamic and community profiles of the user. For a non-limiting example, the questions may focus on the user's personal interest, which may not be truly obtained by simply observing the user's purchasing habits.

In some embodiments, the profile engine updates the profile of the user via the profiling component 114 based on the prior history/record and dates of one or more of:
problems that have been raised by the user;
relevant content that has been presented to the user;
script templates that have been used to generate and present the content to the user;
feedback from the user to the content that has been presented to the user.

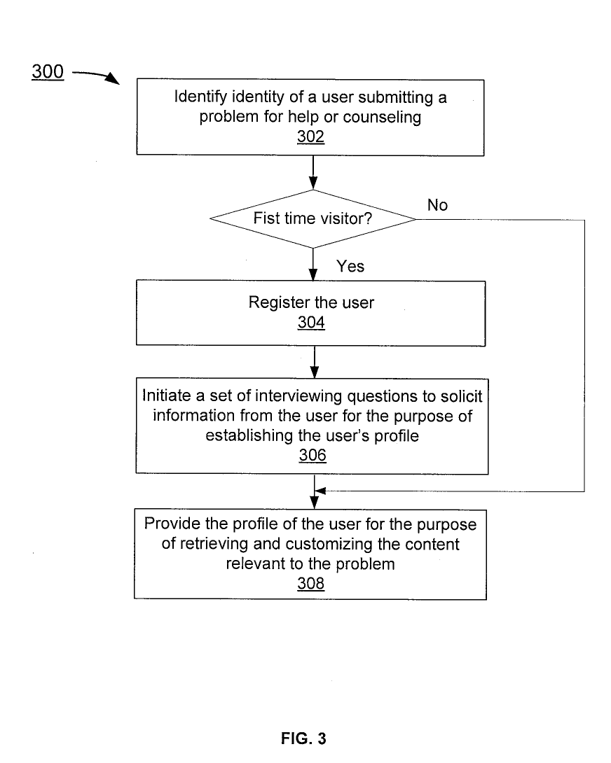

FIG. 3 depicts a flowchart of an example of a process to establish the user's profile. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 3, the flowchart 300 starts at block 302 where identity of the user submitting a problem for help or counseling is identified. If the user is a first time visitor, the flowchart 300 continues to block 304 where the user is registered, and the flowchart 300 continues to block 306 where a set of interview questions are initiated to solicit information from the user for the purpose of establishing the user's profile. The flowchart 300 ends at block 308 where the profile of the user is provided to the content engine 118 for the purpose of retrieving and customizing the content relevant to the problem.

In the example of FIG. 1, the content engine 118 identifies and retrieves the content relevant to the problem submitted by the user via the content retrieval component 122 and customizes the content based on the profile of the user via customization component 124 in order to present to the user a unique experience. A script of content herein can include one or more content items, each of which can be individually identified, retrieved, composed, and presented by the content engine 118 to the user online as part of the user's multimedia experience (MME). Here, each content item can be, but is not limited to, a media type of a (displayed or spoken) text (for a non-limiting example, an article, a quote, a personal story, or a book passage), a (still or moving) image, a video clip, an audio clip (for a non-limiting example, a piece of music or sounds from nature), and other types of content items from which a user can learn information or be emotionally impacted. Here, each item of the content can either be provided by another party or created or uploaded by the user him/herself.

In some embodiments, each of a text, image, video, and audio item can include one or more elements of: title, author (name, unknown, or anonymous), body (the actual item), source, type, and location. For a non-limiting example, a text item can include a source element of one of literary, personal experience, psychology, self help, and religious, and a type element of one of essay, passage, personal story, poem, quote, sermon, speech, and summary. For another non-limiting example, a video an audio, and an image item can all include a location element that points to the location (e.g., file path or URL) or access method of the video, audio, or image item. In addition, an audio item may also include elements on album, genre, or track number of the audio item as well as its audio type (music or spoken word).

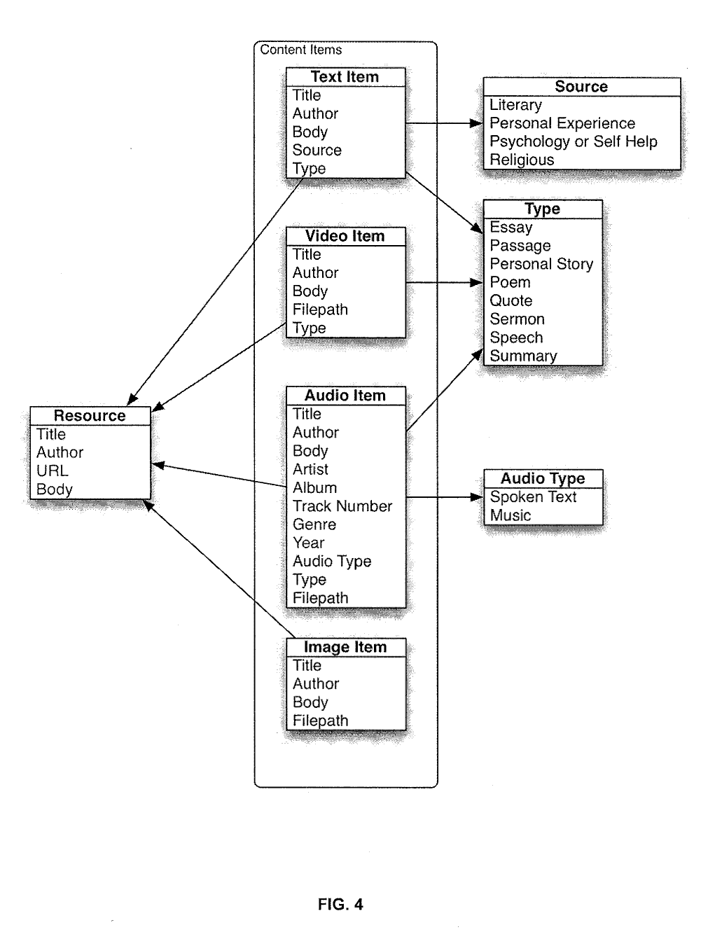

In some embodiments, the content engine 118 can associate each of a text, image, video, and audio item that is purchasable with a link to a resource of the item where such content item can be purchased from an affiliated vendor of the item, such as Amazon Associates, iTunes, etc. The user interaction engine 102 can then present the link together with the corresponding item in the content to the user and enable the user to purchase a content item of his/her interest by clicking the link associated with the content item. FIG. 4 illustrates an example of various types of content items and the potential elements in each of them.

In some embodiments, the content engine 118 may customize the content based on the user's profile including one or more of: the user's prior visits, his/her recent comments and ratings on content related to the same or relevant problems, and his/her response to requests for wisdom. For a non-limiting example, content items that did not appeal to the user in the past based on his/her feedback will likely be excluded. In some situations when the user is not sure what he/she is looking for, the user may simply choose “Get me through the day” from the problem list and the content engine 118 will automatically retrieve and present content to the user based on the user's profile. When the user is a first time visitor or his/her profile is otherwise thin, the content engine 118 may automatically identify and retrieve content items relevant to the problem.

In some embodiments, the content engine 118 may customize the content based on an “experience path” of the user. Here, the user experience path can be a psychological process (e.g., stages of grief: denial→anger→bargaining→depression→acceptance). The user experience path contains an-ordered list of path nodes, each of which represents a stage in the psychological process. By associating the user experience path and path nodes with a content item, the content engine 118 can select appropriate content items for the user that are appropriate to his/her current stage in the psychological process.

In some embodiments, the content engine 118 may identify and retrieve the content in response to the problem raised by the user by identifying a script template for the problem submitted by the user and generating a script of the content by retrieving content items based on the script template. Here, a script template defines a sequence of media types with timing information for the corresponding content items to be composed as part of the multi-media content. For each type of content item in the content, the script template may specify whether the content item is repeatable or non-repeatable, how many times it should be repeated (if repeatable) as part of the script, or what the delay should be between repeats. For repeatable content Items, more recently viewed content Items should have a lower chance of selection that less recently viewed (or never viewed) content items.

In some embodiments, the content engine 118 may adjust or customize the identified or retrieved content based on a plurality of pre-specified rules before presenting such content to the user. Such rules aim at tailoring the presentation of the retrieved content with the user's needs and preferences in mind. For non-limiting examples, the rules may include but are not limited to,
Rule to harmonize color profiles of images or graphics in the content. An image rule may require that all images shown in the content match with each other, or with the color profile of the dominant image, or with color profile of the first image retrieved for the content. For a non-limiting example, if the content contains a scenic picture of a dominantly green or blue profile, the graphics or images surrounding the image should also be harmonized accordingly to match such green or blue profile.
Rule to synchronize content items (especially multi-media content items) in the content. For a non-limiting example, a rule may specify timing and type of transitions of images in the content on the change in tones of the music or audio files in the content being played back. Happy and colorful images can be shown when a light or pleasant tone is being played, while black and white images can be shown when a more sober tone is being played.
Rule to adjust the presentation of the content based on the profile of the user. Such a rule may dictate that the content be adjusted based on age, gender and/or belief system of the user. For a non-limiting example, if the profile indicates that the user is an Islamic woman, a primarily green profile can be adopted for the presentation of the content to suit her gender and/or religious beliefs. For another example, the content to be adjusted according to the age of the user—bright and cheerful presentation for children, classical and smooth presentation for adults. For another non-limiting example, another rule may dictate that, when the profile contains ADA-Compliant information of the user, such as poor eyesight, hearing loss, etc., items in the content should be modified accordingly to adapt to the user's present physical conditions in order to be ADA-Compliant before being presented to the user.

In the example of FIG. 1, the rule library 130 embedded in a computer readable medium, which in operation, maintains a set rules used to customize content before the content is presented to the user. These rules are pre-specified and maintained in the rule library 130 and are retrieved and applied to the content once the content is identified and retrieved. One or more rules in the rule library 130 can be updated periodically and can be applicable to content retrieved for any user. In some embodiments, some rules can be optionally specified by the user and applies only to a content to be presented to the user. Under such scenario, the user-specified and user-specific can be so tagged and are only retrieved and applied when a content is being generated specifically for the user.

In the example of FIG. 1, the profile library 116 embedded in a computer readable medium, which in operation, maintains a set of user profiles of the users. Once the content has been generated and presented to a user, the profile of the user stored in the profile library 116 can be updated to include the problem submitted by the user as well as the content presented to him/her as part of the user history. If the user optionally provides feedback on the content, the profile of the user can also be updated to include the user's feedback on the content.

In the example of FIG. 1, the script template library 126 embedded in a computer readable medium, which in operation, maintains script templates corresponding to the pre-defined set of problems that are available to the user, while the content library 128 embedded in a computer readable medium, which in operation, maintains content items as well as definitions, tags, and resources of the content relevant to the user-submitted problems. In some embodiments, the content engine 118 may automatically generate a script template for the problem by periodically data mining the relevant content items in the content library 128. More specifically, the content engine 118 may first browse through and identify content item's categories in the content library 128 that are most relevant to the problem submitted. The content engine 118 then determines the most effective way to present such relevant content items based on, for non-limiting examples, the nature of the content items (e.g., displayable or audible), and the feedback received from users as how they would prefer the content items to be presented to them to best address the problem. The content engine 118 then generates the script template for the problem and saves the template in the script library 126.

In the example of FIG. 1, the content library 128 covers both the definition of content items and how the content tags are applied. It may serve as a media “book shelf” that includes a collection of content items relevant and customized based on each user's profile, experiences, and preferences. The content engine 118 may retrieve content items either from the content library 128 or, in case the content items relevant are not available there, identify the content items over the Web and save them in the content library 128 so that these content items will be readily available for future use.

In some embodiments, the content items in content library 128 can be tagged and organized appropriately to enable the content engine 118 to access and browse the content library 128. Here, the content engine 118 may browse the content items by problems, types of content items, dates collected, and by certain categories such as belief systems to build the content based on the user's profile and/or understanding of the items' “connections” with the problem submitted by the user. For a non-limiting example, a sample music clip might be selected to be included in the content because it was encoded for a user with an issue of sadness.

In some embodiments, the content engine 118 may allow the user to add self-created content items (such as his/her personal stories, self-composed or edited images, audios, or video clips) into the content library 128 and make them available either for his/her own use only or more widely available to other users who may share the same problem with the user.

In some embodiments, the content engine 118 may occasionally include one or more content items in the customized content for the purpose of gathering feedback from the user. Here, the content items can be randomly selected by the content engine 118 from categories in the content library 128 that are relevant to the problem submitted by the user. Such content items may be newly generated and/or included in the content library 128 and have not been provided to users on a large scale. It is thus important to gather feedback on such content items from a group of users in order to evaluate via feedback such content.

In some embodiments, each content item in content library 128 can be associated with multiple tags for the purpose of easy identification, retrieval, and customization by the content engine 118 based on the user's profile. For a non-limiting example, a content item can be tagged as generic (default value assigned) or humorous (which should be used only when humor is appropriate). For another non-limiting example, a pair of (belief system, degree of adherence range) can be used to tag a content item as either appropriate for all Christians (Christian, 0-10) or only for devout Christians (Christian, 8-10). Thus, the content engine 118 will only retrieve a content item for the user where the tag of the content item matches the user's profile.

In some embodiments, the content engine 118 incorporates wisdom from a community of users and experts into the customized content. Here, the wisdom can simply be content items such as expert opinions and advice that have been supplied in response to a request for wisdom (RFW) issued by the user. The content items are treated just like any other content items once they are reviewed and rated/commented by the user.

While the system 100 depicted in FIG. 1 is in operation, the user interaction engine 102 enables the user to login and submit a problem of his/her concern via the user interface 104. The user interaction engine 102 communicates the identity of the user together with the problem raised by the user to the content engine 118 and/or the profile engine 110. If the user is visiting for the first time, the profile engine 110 may interview the user with a set of questions in order to establish a profile of the user that accurately reflect the user's interests or concerns. Upon receiving the problem and the identity of the user, the content engine 118 obtains the profile of the user from the profile library 116 and the script template of the problem from the script template library 126, respectively. The content engine 118 then identifies and retrieves content items based on the script template of the problem from the content library 128 via the content retrieval component 122 and populates the script template based on the user's profile to create a script of the content that address the user's problem via the customization component 124. Once the content is generated, the content can be adjusted or customized based on a set of rules with the user's needs and preferences in mind before the content is presented to the user. Once customized, the user interaction engine 102 presents it to the user via the display component 106 and enables the user to rate or provide feedback to or optionally download or purchase the content presented. The profile engine 110 may then update the user's profile with the history of the problems raised by the user, the content items presented to the user, and the feedback and ratings from the user of the content.

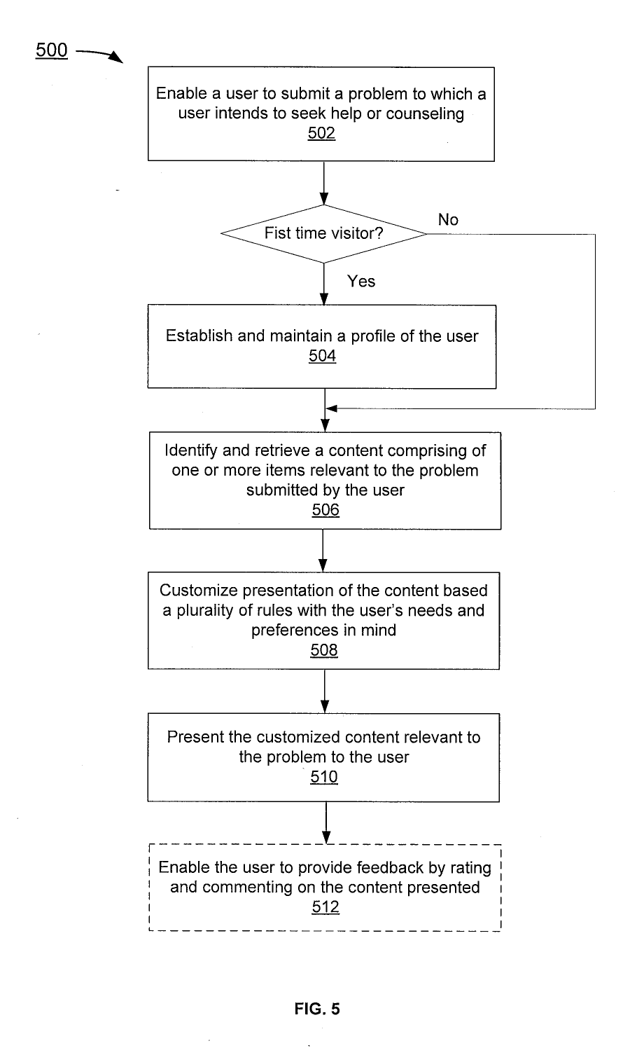

FIG. 5 depicts a flowchart of an example of a process to support rule-based content customization for user presentation. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 5, the flowchart 500 starts at block 502 where a user is enabled to submit a problem to which the user intends to seek help or counseling. The problem submission process can be done via a user interface and be standardized via a list of pre-defined problems organized by topics and categories.

In the example of FIG. 5, the flowchart 500 continues block 504 where a profile of the user is established and maintained if the user is visiting for the first time or the user's current profile is otherwise thin. At least a portion of the profile can be established by initiating interview questions to the user targeted at soliciting information on his/her personal interests and/or concerns. In addition, the profile of the user can be continuously updated with the problems raised by the user and the scripts of content presented to him/her.

In the example of FIG. 5, the flowchart 500 continues block 506 where a content comprising one or more content items that is relevant to the problem submitted by the user is identified and retrieved. Here, content items can be automatically identified and retrieved based on a script template associated with the problem submitted by the user and a script of the content can be formed by “filling” the script template with the content retrieved.

In the example of FIG. 5, the flowchart 500 continues block 508 where presentation of the retrieved content is customized based on a set of rules. Such customization aims at adjusting the retrieved content with the user's needs and preferences in mind and the rules can be based on the profile of the user.

In the example of FIG. 5, the flowchart 500 ends at block 510 where the customized content relevant to the problem is presented to the user. Optionally, the user may also be presented with links to resources from which items in the presented content can be purchased. The presented content items may also be saved for future reference.

In the example of FIG. 5, the flowchart 500 may optionally continue to block 512 where the user is enabled to provide feedback by rating and commenting on the content presented. Such feedback will then be used to update the profile of the user in order to make future content customization more accurate.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “interface” is used in the embodiments of the systems and methods described above, it will be evident that such concept can be interchangeably used with equivalent software concepts such as, class, method, type, module, component, bean, module, object model, process, thread, and other suitable concepts. While the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system, comprising:
a profile engine, which in operation, establishes and maintains a profile of a user;
a user interaction engine, which in operation,
enables the user to submit a problem to which the user intends to seek help or counseling;
presents to the user a content relevant to addressing the problem submitted by the user;
a content engine, which in operation,
identifies and retrieves the content relevant to the problem submitted by the user;
customizes the retrieved content based on a plurality of rules before presenting the content to the user.

2. The system of claim 1, wherein:
the plurality of rules aim at tailoring presentation of the retrieved content with the user's needs and preferences in mind.

3. The system of claim 1, wherein:
one of the plurality of rules harmonizes color profiles of images or graphics in the content.

4. The system of claim 1, wherein:
one of the plurality of rules adjusts presentation of the content based on the profile of the user.

5. The system of claim 1, wherein:
one of the plurality of rules is applicable to content retrieved for any user.

6. The system of claim 1, wherein:
one of the plurality of rules is user-specified and applicable only to the content retrieved for the user.

7. The system of claim 1, wherein:
the profile of the user includes one or more of: name, address, date of birth, age, gender, parental status, marital status, relationship status, ADA-Compliant information, belief system, psycho-spiritual dimensions, personal interests, hobbies, habits of the user.

8. The system of claim 1, wherein:
the profile of the user includes history of one or more of:
problems that have been raised by the user;
relevant content that have been presented to the user;
script templates that have been used to present the content to the user;
feedback from the user to the content that have been presented to the user.

9. The system of claim 1, wherein:
the profile engine initiates one or more questions to the user to solicit information for the purpose of establishing the profile of the user.

10. The system of claim 1, wherein:
the user interaction engine is configured to enable the user to provide feedback to the content presented.

11. The system of claim 10, wherein:
the profile engine updates the profile based on the problem, content, and feedback from the user.

12. The system of claim 1, wherein:
the user interaction engine is configured to enable the user to download or purchase the content presented.

13. The system of claim 12, wherein:
the user interaction engine is configured to enable the user to download or purchase the content presented in the form of computer readable media.

14. The system of claim 12, wherein:
the user interaction engine is configured to enable the user to download or purchase the content presented in the form of printable media.

15. The system of claim 1, wherein:
the content engine
identifies a script template in the script template library relevant to the problem submitted by the user;
customizes the script template based on the profile of the user;
retrieves the content based on the script template.

16. The system of claim 1, wherein:
the content includes one or more items, wherein each of the one or more items is a text, an image, an audio, or a video item.

17. The system of claim 16, wherein:
one of the plurality of rules synchronizes the one or more items in the content.

18. The system of claim 16, wherein:
the content engine associates a link to a resource of each item in the content.

19. The system of claim 16, wherein:
the user interaction engine presents the link together with the corresponding item in the content to the user.

20. The system of claim 1, wherein:
the content engine customizes the content based on the user's profile including one or more of: the user's prior visits, his/her recent comments and ratings on content related to the same or relevant problems, and his/her response to requests for wisdom.

21. The system of claim 1, wherein:
the content engine customizes the content based on an experience path of the user.

22. The system of claim 1, wherein:
the content engine includes one or more randomly selected content items in the content for the purpose of gathering feedback from the user.

23. A computer-implemented method, comprising:
establishing and maintaining a profile of a user;
enabling the user to submit a problem to which the user intends to seek help or counseling;
identifying and retrieving a content relevant to the problem submitted by the user;
customizing the content based on a plurality of rules with the user's needs and preferences in mind;
presenting the customized content relevant to the problem to the user.

24. The method of claim 23, further comprising:
harmonizing color profiles of images or graphics in the content via one of the plurality of rules.

25. The method of claim 23, further comprising:
synchronizing one or more items in the content via one of the plurality of rules.

26. The method of claim 23, further comprising:
adjusting presentation of the content based on the profile of the user via one of the plurality of rules.

27. The method of claim 23, further comprising:
enabling user-specification of one of the plurality of rules, wherein the rule applicable only to the content retrieved for the user.

28. The method of claim 23, further comprising:
initiating one or more questions to the user to solicit information for the purpose of establishing the profile of the user.

29. The method of claim 23, further comprising:
enabling the user to provide feedback to the content presented.

30. The method of claim 29, further comprising:
updating the profile based on the problem, content, and feedback from the user.

31. The method of claim 23, further comprising:
enabling the user to download or purchase the content presented.

32. The method of claim 31, further comprising:
enabling the user to download or purchase the content presented in the form of computer readable media.

33. The method of claim 31, further comprising:
enabling the user to download or purchase the content presented in the form of printable media.

34. The method of claim 23, further comprising:
identifying a script template for the problem submitted by the user;
customizing the script template based on the profile of the user;
retrieving the content based on the script template.

35. The method of claim 23, further comprising:
generating a script template for the problem automatically by periodically data mining relevant content items.

36. The method of claim 23, further comprising:
maintaining definitions, tags, and source of content relevant to user-submitted problems.

37. The method of claim 23, further comprising:
tagging the content appropriately for the purpose of easy identification, retrieval, and customization.

38. The method of claim 23, further comprising:
associating a source of or a link to each item in the content;
presenting the source and the link together with the corresponding item in the content to the user.

39. The method of claim 23, further comprising:
customizing the content based the user's profile including on one or more of: the user's prior visits, his/her recent comments and ratings on content related to the same or relevant problems, and his/her response to requests for wisdom.

40. The method of claim 23, further comprising:
customizing the content based on an experience path of the user.

41. The method of claim 23, further comprising:
including one or more randomly selected content items in the content for the purpose of gathering feedback from the user.

42. A system, comprising:
means for establishing and maintaining a profile of a user;
means for enabling the user to submit a problem to which the user intends to seek help or counseling;
means for identifying and retrieving a content relevant to the problem submitted by the user;
means for customizing the content based on a plurality of rules with the user's needs and preferences in mind;
means for presenting the customized content relevant to the problem to the user.

43. A machine readable medium having software instructions stored thereon that when executed cause a system to:
establish and maintain a profile of a user;
enable the user to submit a problem to which the user intends to seek help or counseling;
identify and retrieve a content relevant to the problem submitted by the user;
customize the content based on a plurality of rules with the user's needs and preferences in mind;
present the customized content relevant to the problem to the user.
